(19) United States
(12) Patent Application Publication
(10) Pub. No.: US 2012/0054348 A1
(43) Pub. Date: Mar. 1, 2012

(54) Method for the initiation of a shared computer session

(76) Inventor: Clemens Karl Bernhard Röllgen, Munich (DE)

(21) Appl. No.: 12/807,152

(22) Filed: Aug. 30, 2010

(51) Int. Cl. G06F 15/16

(52) U.S. Cl. 709/227

(57) ABSTRACT

The method provided is for the initiation of a computer session which is shared by two computers that are connected via internet behind NAT routers so that there is no additional relay server necessary. In contrast to conventional methods which can only connect two computers behind NAT routers via a relay server, there is no need to charge users for the incurring additional traffic. The invention regards a method for the initiation of a computer session which is shared by two computers with the following steps:

Manual or automatic start on two computers through a communication software that can exchange arbitrary data via a mutually used rendezvous server. Discovery of the local IP address and of a free port and discovery of the global IP address and port on each side. Transmission of the discovered data to the respective peer via the rendezvous server. Hole punching into the respective opposite NAT. Start of a packet-oriented bidirectional transmission protocol with automatic repeat request.

### CROSS-REFERENCE TO RELATED APPLICATIONS

Not Applicable.

### STATEMENT REGARDING FEDERALLY SPONSERED RESEARCH OR DEVELOPMENT

Not Applicable.

### THE NAMES OF THE PARTIES TO A JOINT RESEARCH AGREEMENT

Not Applicable.

### INCORPERATION-BY REFERENCE OF MATERIAL SUBMITTED ON A COMPACT DISC

Not Applicable.

### BACKGROUND OF THE INVENTION

The invention relates to a method that initiates a computer session which is shared by two computers connected via internet. The two computers are located behind different NAT routers in different Local Area Networks.

Methods for sharing a computer session on two computers and their initiation are known as Desktop Sharing Applications. Shared use of a computer session is made possible by displaying the screen content of the remote computer and by enabling for remote manipulation of the desktop. Computer programs as “Virtual Network Computing (VNC)” or “Microsoft Remote Desktop”, which are both widely used for remote administration of computers, are commonly known. In contrast to this make “Desktop Viewing” Applications only the screen content of the remote computer visible. Remote control of the remote computer is not possible with “Desktop Viewing” applications like “Skype”.

Desktop sharing software is always divided into a server program that is running on a first computer and whose screen content is to be shared and a client program running on a second computer. The client program receives data from the first computer representing the screen content of the first computer and renders that on the local display of the second computer. The client program is capable of sending keyboard and mouse events incurring on the second computer to the server program running on the first computer. The server program subsequently simulates the received keyboard- and mouse events on the first computer as if these events originated from the keyboard and pointer device physically connected to the first computer.

The premise for conventional desktop sharing methods is free access from the internet to the computer that is executing the desktop sharing server program. This is typically the case for servers because it is anyways advisable for these computers to be directly addressable from a Wide Area Network—the Internet. Easy accessibility of a computer from a WAN implies knowledge of the computer's IP address and that the communication port that the server program is listening for inbound data packets is known and that it is open for data traffic. A desktop sharing client program running on a first computer is consequently able to establish a data connection through the WAN to the desktop sharing server program running on a second computer. The initiation of a desktop sharing session consequently takes place ad hoc. Desktop Sharing methods have so far almost always been used for the remote administration of servers.

Over the last couple of years desktop sharing methods have increasingly been used in offices for the collaboration of two or more employees. Computers located in offices or in home networks are predominantly operated in local area networks. For local area networks, an unofficial standard has de facto won through: Destination addresses and ports of data packets originating from computers in the local network are altered by so-called NAT routers prior to transmitting them into the WAN. Therefore all data packets are always tagged with the same IP address when passing from the LAN over to the WAN—the one of the NAT router. NAT routers act in the WAN as a proxy for a plurality of computers located in a LAN. This trick enables one to address a much greater number of computers than would otherwise be possible to address with the limited address range of IPv4. NAT routers buffer the assignment of target addresses and ports and are thus able to forward inbound data packets from the WAN to the corresponding computer in the LAN. NAT stands for “Network Address Translation”. Data packets originating from an unknown source in the WAN, to which no contact existed seconds before, are simply dropped by a NAT router. Very secure NAT routers even buffer connection information only for as much time as communication with a very slow server via a very long route would take at maximum. Connection information is consequently buffered in NAT routers according to the internal security rules for a few seconds only.

In contrast to the remote administration of servers suffer desktop sharing applications as well as any other software from being prohibited from establishing direct contact with a computer in a foreign LAN with an upstream connected NAT router. The NAT router of the foreign LAN simply drops unexpected inbound data packets that originate from an unknown source. Desktop sharing methods that are specifically used for the collaboration of one or more participants in offices use a way around for the establishment of their connection. This detour works with very high reliability: the entire communication is carried out via an easily accessible server in the WAN, a so-called relay server. Due to characteristic of NAT routers to forward inbound data packets from a source in the WAN that has been contacted seconds ago from within the LAN via the very same port will any commercially available NAT router forward data packets from the relay server into the LAN. The relay server itself simply forwards all data packets received from computer 1 to computer 2, which is located behind a different NAT router in a different LAN than computer 1. As long as data packets of a collaboration desktop sharing session are sent by all participating desktop sharing programs every few seconds to the relay server in the WAN, no interconnected NAT router will drop inbound data packets that origin from the relay server. All interconnected NAT routers will instead forward data packets to the corresponding endpoints. Collaboration desktop sharing programs therefore sometimes need to send empty data packets in conformance with the desktop sharing protocol. These dummy packets are simply dropped by the relay server in the WAN.

In order to enable the relay server to support different collaboration desktop sharing sessions simultaneously every session is marked with an unique identifier number or a unique character string. All participants of a collaboration desktop sharing session need to log on the relay server with this unique identifier. According to the state of technology it is common that one of the participants of a planned desktop sharing session fetches a new session identifier from the relay server and subsequently informs all other participants by e-mail or by telephone. Fetching of a session identifier from the relay server is typically performed by connecting to the relay server with a web browser.

This procedure is tedious for users and not every user understands the procedural steps intuitively. The reason for taking a substantial detour for all data packets, for taking account much higher data traffic and for troublesome handling by users is the poor method for the initiation of a shared computer session on two or more computers.

Moreover can total traffic that needs to be handled by a relay server be of substantial extent. A color display with 1280×1024 pixels contains roughly 3.9 megabyte of image data. A color monitor with 1920×1200 pixels displays 6.9 megabyte of image data that need to be transported to the relay server. Through the use of data compression algorithms e.g. like Lempel-Ziv, arithmetic compression, Huffman- and/or discrete cosine transformation, a compression ratio of 95% is within reach. This still corresponds with up to approximately 340 kilobyte of image data for each full frame. Favorably designed desktop sharing methods rarely transmit full frames. If possible only changed screen areas are transmitted in a timely fashion. Data volume still adds up to an average of 20 . . . 40 kilobyte per second. A single 60-minute collaboration desktop sharing session with two participants accounts for 140 megabyte of upstream traffic.

In comparison with other internet applications, data traffic is high. Due to this reason are providers of collaboration desktop sharing solutions forced to charge the accumulated data traffic to user's accounts from time to time.

### BRIEF SUMMARY OF THE INVENTION

The method provided is for the initiation of a computer session which is shared by two computers connected via internet so that there is no need for a costly relay server and so that users do not need to execute tedious procedures in order to start desktop sharing sessions. The method is executed by a computer program that takes the following steps:
the method can exchange data between two computers at any time via relay server through an IP phone software,
local IP addresses and open ports are discovered by the method running on both computers,
global IP address and ports of the two NAT routers are discovered locally by contacting a server in the WAN that is specifically designed for this purpose,
the discovered IP addresses and ports are transferred via IP telephones running on both computers through the relay server,
both computers contact each other via UDP hole punching directly in order to override the network address translation functions of the NAT routers,
start of a packet-based bidirectional transmission protocol with Automatic Repeat reQuest (ARQ) through the now open ports.

### DETAILED DESCRIPTION OF THE INVENTION

The invention underlies the problem of a method for the initiation of a computer session which is shared by two computers connected via internet so that there is no need for a costly relay server and so that users do not need to execute tedious procedures in order to start desktop sharing sessions with:
a communication software, preferably an IP telephony software running on both computers that allows the method running on both computers to exchange data via relay server at any time
discovery of the local IP addresses and open ports by the method running on both computers
discovery of the global IP addresses and ports of the NAT router by contacting a server in the WAN that is specifically designed for this purpose
transfer of the discovered IP addresses and ports via the IP telephony communication software which in turn transfers the information via the relay server to the respective peer, so that detailed information about how to address the respective peer directly is available for the method running on the respective opposite computer
execution of UDP hole punching directly between the two peers to override the network address translation functions of the NAT routers that both peers are physically located behind
starting of a packet-based bidirectional transmission protocol with Automatic Repeat reQuest (ARQ) subsequent to successfully signaling the NAT functionalities of the NAT routers to open the punched ports in order to enable for the transmission of buffered data to the network layer of a desktop sharing method running on both computers.

Through this, the previously described disadvantages do not occur.

A method for the initiation of a computer session which is shared by two computers connected via internet that is according to the invention is preferably started by the users via communication software that is running on both computers. It is according to the human nature to talk on the phone and to decide at the beginning or at some point of time during a call or a video conference to collaborate by sharing the desktop of one of the participants of the conversation. The communication software allows for the exchange any data of a projected desktop sharing session between the two computers. As soon as both participants decide to collaborate by starting a desktop sharing session, the method discovers the local IP address and port, as well as the global IP address and port, which the NAT router assigns to data packets that are sent into the WAN. The local IP address can be queried on all operating systems by calling a function of the operating system that is part of the Internet Protocol Suite. The global IP address can be determined preferably by contacting a STUN server. Session Traversal Utilities for NAT” (STUN), RFC 5389, is a network protocol that has been developed specifically for the detection and classification of NAT routers. The STUN client, as well as the STUN server, mutually add the source IP address and port from where they have received data packets. This enables for the easy determination of the public IP address of a gateway and if a NAT router changes the port for data packets.

A method that is according to the invention transfers the collected IP address and port information, at least although the global IP address and port in the WAN to the respective peer. In order to transmit this data, the already existing connection of both peers to the telephony server, which is preferably a SIP server, is taken advantage of. SIP (Session Initiation Protocol) is a popular protocol for IP telephones with a corresponding telephony server. SIP offers the advantage that almost any kind of attachments can be added to short messages. These short messages can be sent to any clients connected to the SIP server. A method that is according to the invention takes advantage of this feature or alternatively it sends NOTIFY messages to the endpoints that are currently in a mutual telephony session. After having coincidentally discovered and exchanged the data that is necessary to contact the respective peer directly, both instances of the method that is executed on both computers start to fire repeatedly short messages to the public IP address and public port of the respective peer. The NAT router installed upstream to the respective peer computer drops inbound data packets according to its security rule. As soon as the computer that is connected behind the respective NAT router starts to establish a connection to the remotely located peer computer by sending data packets to the device, the NAT router that is installed upstream can only interpret inbound data packets from that specific address in the WAN as wanted reply of a server and forward this data to the computer behind it. This procedural step is known as “Hole Punching” and this technique works with almost all NAT routers from well-known manufacturers for the non-connection oriented UDP network protocol. In contrast to this is TCP hole punching only compatible with approximately ⅔ of all commercial NAT routers. The reason for this is that the actual target IP address differs from the one of the STUN server. The characteristics of a connection-oriented network protocol like TCP depend on the originally contacted IP address. TCP connections with different targets are frequently routed via different ports. Replies from different sources are thus identified as unsolicited data traffic by many NAT routers and subsequently dropped. In contrast to this do almost all commercial NAT routers react cooperatively to UDP hole punching due to the non-connection oriented nature of the protocol. After a few attempts to punch a “hole” into both firewalls will the method that is executed on both computers have established the possibility to directly communicate with each other and then start a bidirectional data protocol with Automatic Repeat reQuest (ARQ) that is used to transfer data in a collaboration desktop sharing session. Automatic repeat requests make guaranteeing of the integrity of user data possible. The UDP network protocol does not offer this feature. A method that is according to the invention preferably takes advantage of automatic repeat requests with selective repetition. A missing data packet or one that contains erroneous data is dropped, but all subsequently received data packets are saved in a buffer and their reception is acknowledged. If the wait time span for the reception acknowledgement of a data packet is exceeded or if the receiver requests the re-transmission of the data packet, the oldest data packet for which reception has not yet been acknowledged or the actually requested data packet is sent to the receiver once again. If this data packet is received correctly by the receiver, the method that is executed on the receiving computer can then send all buffered data packets to the network layer of the desktop sharing method.

The TCP network protocol that is typically used for conventional desktop sharing methods for data transport uses in contrast the more simple “Go-Back-N” repetition method. With this repetition method, N data packets are sent prior to waiting for a reception acknowledgement. The receiver typically acknowledges the reception of a number of data packets cumulatively. If no reception acknowledgement arrives within a certain time span, the sender retransmits all data packets for which reception has not yet been acknowledged. It is although possible that only a single data packet out of a great number of packets has not been properly transferred. Nevertheless are all following N packets retransmitted with the Go-Back-N repetition method with the result that precious data bandwidth is wasted.

The decisive advantage of a method for the initiation of a computer session which is shared by two computers connected via interne that is according to the invention is its intuitive use and that an entire server is economized. Running costs for this server as so high that users need to be billed for these costs now and in the future. One click at a mouse button is sufficient to start a method that is according to the invention. There is no need for users to acquire session identifiers, to distribute them to other participants and to enter them manually. Unneeded data traffic is omitted. In fact is data traffic in comparison with a conventional collaboration desktop sharing session similar for the participants, but the relay server does not exist and this cuts the total traffic down to half. A method that is according to the invention enables internet telephony providers to offer desktop sharing without the need to bill for additional costs.

### BRIEF DESCRIPTION OF DRAWINGS

FIG. 1 is the schematic representation of an embodiment of a method for the initiation of a computer session which is shared by two computers connected via internet so that there is no need for a costly relay server and so that users do not need to execute tedious procedures in order to start desktop sharing sessions.

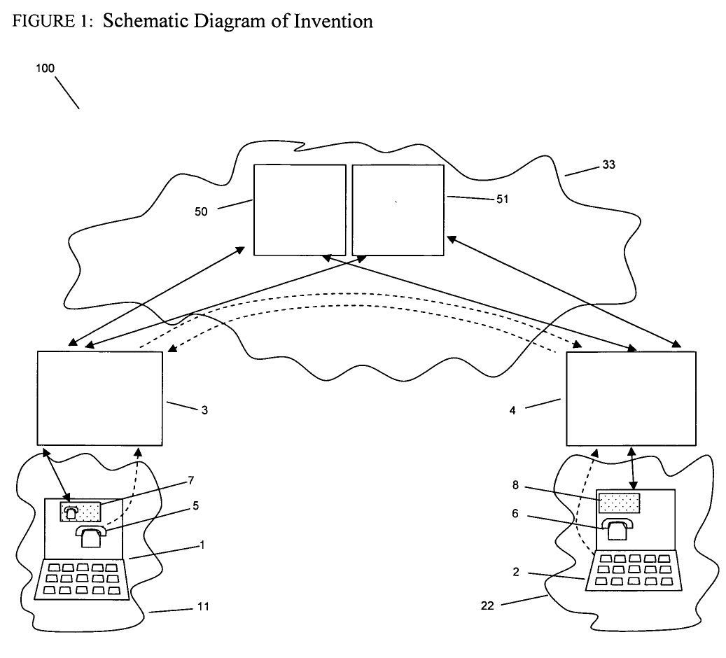

The schematic diagram (FIG. 1) represents a method for the initiation of a computer session which is shared by two computers connected via internet so that there is no need for a costly relay server and so that users do not need to execute tedious procedures in order to start desktop sharing sessions labeled with the reference sign (100).

Method (100), which is started by two users on two computers (1) and (2) with the help of a communication software (5) and (6), preferably utilizes the UDP network protocol. The method (100) is able to exchange any kind of data between the two computers (1) and (2) through the mutually used relay server (50). The relay server (50) is preferably a SIP telephony server that is anyways used by the communication software (5) and (6) to exchange data between the two computers (1) and (2). The computers (1) and (2) are located in different local area networks (11) and (22) that are each connected to the WAN (33) via the NAT routers (3) and (4).

The local IP addresses and ports of the two computers (1) and (2) in the respective LAN (11) and (22) are determined by calling the corresponding functions in the operating system.

The two global IP addresses and ports of the respective NAT routers (3) and (4) are subsequently discovered by the method (100) executed on both computers (1) and (2). For this purpose are STUN data packets sent by both computers (1) and (2) to a STUN server (51) in the WAN.

The respective NAT router (3) or (4) identifies the outbound data traffic as being addressed to a specific IP address in the WAN (33) and memorizes a data tuple consisting of the target IP address and port, as well as the IP address and port inside the LAN (11) or (22) in order to be able to route a future reply from the addressed STUN server (51) to the respective computer (1) or (2). The STUN server (51) saves the IP address and port of the respective source (3) or (4) in all received data packets and sends these changed data packets back to the respective addressee, the NAT router (3) or (4). The NAT router (3) or (4) finally forwards these data packets to the respective recipient, computer (1) or (2).

Only now it is possible for the method (100) that is executed on the first computer (1) to contact the second computer (2) directly by sending short data packets in fast succession to the public IP address of the NAT router (4) in the WAN (33), which is connected upstream to the second computer (2).

The method (100) that is executed on the second computer (2) almost coincidentally sends short data packets to the public IP address and port of the NAT router (3) that is connected upstream to the first computer (1) with the WAN (33). As soon as data packets appear to be replies from the previously addressed endpoint in the WAN to a NAT router (3) or (4), the NAT router (3) or (4) supposes that these replies stem from a server and passes these replies to the respective computer (1) or (2) in the LAN (11) and (22). With the aid of this signaling method known as “hole punching” it is possible for the first computer (1) to exchange data directly with the second computer (2) and vice versa. The UDP network protocol is preferably used. If although TCP is used, the method (100) is as well compatible with a multitude of commercial NAT routers (3) or (4).

In the final procedural step of the method (100), a packet-based bidirectional communication protocol with automatic repeat request is started. This enables for direct bidirectional exchange of data for a desktop sharing session between the first computer (1) and the second computer (2). Due to the sometimes enormous data traffic incurring on possibly unexpectedly long and fragile lines in the WAN that may even suffer from frequent loss of data, use of automatic repeat requests with selective repetition is preferred. This measure prevents unnecessary data traffic from occurring. Buffered data that is essentially required for shared use of a computer session on two computers is hereby transferred to the network layer of a conventional desktop sharing method (7) and (8) in a highly efficient way and with minimum time delay.

1. A method for the initiation of a computer session which is shared by two computers that are connected via internet, the method comprising the steps of:
Manual or automatic start on two computers that are located in different local area networks behind different NAT routers, which are connected to the internet/WAN, through a communication software that is running on both computers and that is able to exchange arbitrary data via a mutually used rendezvous server;
Discovery of the local IP address and determination of an unused port on both computers;
Discovery of the global IP address and port of both NAT routers with both computers exchanging data with a server that adds to its replies to both computers the respective source IP address and port in order to later make available detailed information on how to address the respective opposite computer;
Transmission of the global IP address and port of the respective remotely located NAT router to the respective opposite computer via a rendezvous server or via a communication software running on both computers that is already directly communicating with the rendezvous server;
Both computers directly contacting each other through the surmounting of the network address translating functionality in the NAT routers by punching a hole into the respective opposite NAT router;
Start of a packet-oriented bidirectional transmission protocol with automatic repeat request that makes available buffered data, which is required for the shared use of a computer session, to the network layer of a desktop sharing method that is executed on both computers;

2. The method for the initiation of a computer session which is shared by two computers that are connected via internet as recited in claim 1, wherein the rendezvous server is a telephony server and the communication software is a software telephone.

3. The method for the initiation of a computer session which is shared by two computers that are connected via internet as recited in claim 1, wherein the server that adds to its replies to both computers the respective source IP address and port utilizes the STUN protocol (RFC 5389/RFC 3489) or a protocol that is functionally comparable to the STUN protocol.
